(19) United States
(12) Patent Application Publication
(10) Pub. No.: US 2023/0214045 A1
(43) Pub. Date: Jul. 6, 2023

(54) ELECTRONIC DEVICE AND OPERATION METHOD THEREFOR

(71) Applicant: ASUSTEK COMPUTER INC., TAIPEI (TW)

(72) Inventor: Sih Ci LI, TAIPEI (TW)

(21) Appl. No.: 17/893,541

(22) Filed: Aug. 23, 2022

(30) Foreign Application Priority Data
Jan. 6, 2022 (TW) 111100606

(51) Int. Cl. G06F 3/041; G06F 3/0346; G06F 3/01

(52) U.S. Cl. CPC G06F 3/0416; G06F 3/0346; G06F 3/017

(57) ABSTRACT

An operation method for an electronic device is provided. The electronic device includes a display area and a non-display area. The non-display area includes a sensing area. The operation method includes: detecting whether an application program is executed on the electronic device or not, and when the application program is executed on the electronic device, enabling a touch control area in the sensing area, where a position of the touch control area is related to the application program; and receiving a touch control signal on the touch control area and executing a function of the application program in response to the touch control signal. An electronic device for executing the operation method is also provided.

### CROSS-REFERENCE TO RELATED APPLICATION

This application claims the priority benefit of Taiwan application serial No. 111100606, filed on Jan. 6, 2022. The entirety of the above-mentioned patent application is hereby incorporated by reference herein and made a part of the specification.

### BACKGROUND OF THE INVENTION

### Field of the Invention

The disclosure relates to an electronic device and an operation method therefor, and in particular, to an electronic device of a touch control operation and an operation method therefor.

### Description of the Related Art

With the performance enhancement of handheld electronic devices, more and more users use the handheld electronic devices to perform complex operations, such as word processing or online gaming. However, because touch control screens of the handheld electronic devices are not large enough, it is usually not easy for the users to perform the operations or the line of sight is blocked by fingers.

### BRIEF SUMMARY OF THE INVENTION

The disclosure provides an operation method for an electronic device. The electronic device includes a display area and a non-display area. The non-display area includes a sensing area. The operation method includes: detecting whether an application program is executed on the electronic device or not, and when the application program is executed on the electronic device, enabling a touch control area in the sensing area, where a position of the touch control area is related to the application program; and receiving a touch control signal on the touch control area and executing a function of the application program in response to the touch control signal.

The disclosure further provides another operation method for an electronic device. The electronic device includes a display area and a non-display area. The non-display area includes a sensing area. The operation method includes: detecting whether an application program is executed on the electronic device or not, and when the application program is executed on the electronic device, enabling a plurality of touch control areas in the sensing area, where each touch control area corresponds to a function of the application program; and receiving a touch control signal on one of the touch control areas and executing the corresponding function based on the touch control area in which the touch control signal is located.

The disclosure further provides an electronic device. The electronic device includes a display area, a non-display area, a processing unit, and a control unit. The non-display area includes a sensing area. The processing unit is configured to execute an application program. The control unit is configured to detect whether the processing unit executes the application program or not, when the processing unit executes the application program, enable a touch control area in the sensing area, where a position of the touch control area is related to the application program, and instruct the processing unit to execute a function of the application program in response to a touch control signal received in the touch control area.

The function of the application program is triggered by using the non-display area based on the electronic device and the operation method therefor provided in the disclosure. In this way, more diversified operation modes are provided without installing extra extended accessories on the electronic device.

### BRIEF DESCRIPTION OF THE DRAWINGS

FIG. 1 is a schematic front view of an embodiment of an electronic device according to the disclosure;

FIG. 2 is a schematic rear view of an embodiment of an electronic device according to the disclosure;

FIG. 3 is a schematic block diagram of an embodiment of an electronic device according to the disclosure;

FIG. 4 is a schematic diagram of another embodiment of an electronic device according to the disclosure;

FIG. 5 is a schematic block diagram of still another embodiment of an electronic device according to the disclosure;

FIG. 6 is a schematic diagram of an embodiment of an electronic device in FIG. 5 in a horizontal state according to the disclosure;

FIG. 7 is a schematic diagram of an embodiment of an electronic device in FIG. 5 in a vertical state according to the disclosure;

FIG. 8 is a flowchart of an embodiment of an operation method for an electronic device according to the disclosure;

FIG. 9 is a flowchart of another embodiment of an operation method for an electronic device according to the disclosure; and

FIG. 10 is a flowchart of still another embodiment of an operation method for an electronic device according to the disclosure.

### DETAILED DESCRIPTION OF THE EMBODIMENTS

More detailed descriptions of specific embodiments of the disclosure are provided below with reference to the schematic diagrams. The features and advantages of the disclosure are described more clearly according to the following description and claims. It should be noted that all of the drawings use very simplified forms and imprecise proportions, only being used for assisting in conveniently and clearly explaining the objective of the embodiments of the disclosure.

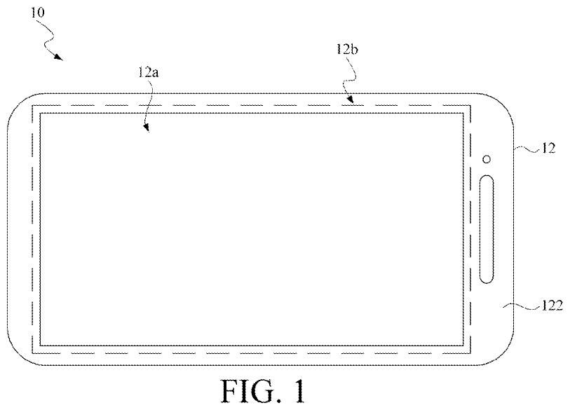

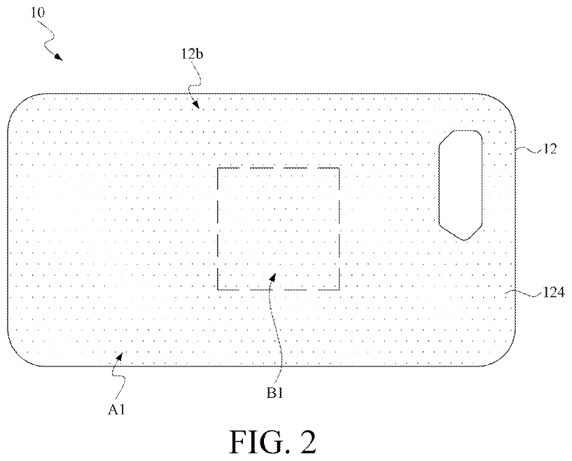

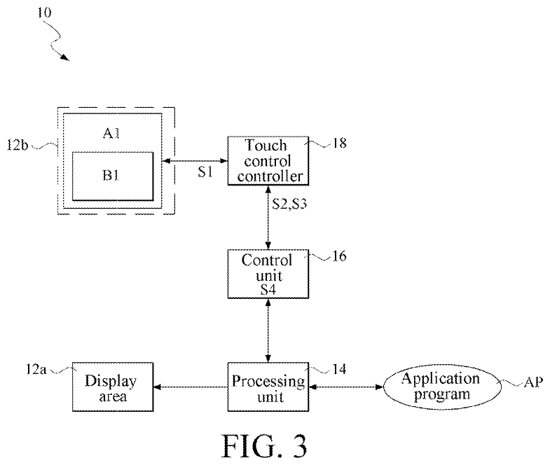

Referring to FIG. 1, FIG. 2, and FIG. 3 together, FIG. 1 is a schematic front view of an embodiment of an electronic device according to the disclosure. FIG. 2 is a schematic rear view of an embodiment of an electronic device according to the disclosure. FIG. 3 is a schematic block diagram of an embodiment of an electronic device according to the disclosure. An electronic device 10 of the disclosure includes an outer frame 122, a back cover 124, a processing unit 14, and a control unit 16.

In an embodiment, the electronic device 10 of the disclosure is a mobile phone, a handheld game console, or a tablet computer.

The electronic device 10 includes a display area 12a and a non-display area 12b. The display area 12a is located on the front of the electronic device 10. The non-display area 12b is mainly located on the back of the electronic device 10 and extends to an edge of the front of the electronic device 10. The non-display area 12b includes a sensing area A1 and a touch control area B1.

In an embodiment, as shown in FIG. 1 and FIG. 2, a display module is accommodated in the outer frame 122, to form the display area 12a. The back cover 124 covers the back of the electronic device 10. A housing 12 of the electronic device 10 is formed by the outer frame 122 and the back cover 124. The sensing area A1 is located on the back cover 124. The sensing area A1 is alternatively located on the outer frame 122, such as an edge of the front of the outer frame 122, or a side of the outer frame 122.

In an embodiment, as shown in FIG. 3, the electronic device 10 includes a touch control controller 18. The touch control controller 18 receives and processes a touch control signal S1 from the sensing area A1, and converts the touch control signal into a digital signal S2 to be outputted outward.

The control unit 16 is configured to detect whether the processing unit 14 executes an application program AP or not, and when the processing unit 14 executes the application program AP, enable a touch control area B1 in the sensing area A1.

In an embodiment, the processing unit 14 is a central processing unit, or a function unit in a central processing unit.

In an embodiment, the control unit 16 is a function unit in the central processing unit, firmware, a software program, or a combination thereof.

In an embodiment, the application program AP is a phone calls program, a camera program, a game program, or a video player program.

In an embodiment, the back cover 124 has a three-dimensional texture at a position corresponding to the touch control area B1, to help a user determine the position of the touch control area B1. In an embodiment, the three-dimensional texture is a three-dimensional pattern, letter, or symbol.

When the processing unit 14 executes the application program AP, a window or a screen corresponding to the application program AP is displayed in the display area 12a. In this case, the control unit 16 enables a touch control function of the sensing area A1 through the touch control controller 18. Meanwhile, the control unit 16 performs subsequent processing on only the digital signal S2 whose touch control position is located within a preset area (that is, the touch control area B1), rather than a digital signal S3 whose touch control position is located out of the preset area (that is, the touch control area B1). In this way, for the touch control function of the sensing area A1 of the electronic device 10, the touch control function of only the touch control area B1 is enabled.

After the control unit 16 enables the touch control area B1, when the touch control area B1 receives the touch control signal S1, the control unit 16 instructs the processing unit 14 to execute a function of the application program AP in response to the touch control signal S1. The function differs as the application program AP differs.

In an embodiment, when the application program AP is the phone calls program, the function is a volume adjustment function. When the application program AP is the camera program, the function is an image scaling function. When the application program AP is the game program, the function is a specific key corresponding to an application program screen displayed in the display area. When the application program AP is the video player program, the function is a volume adjustment function or a fast forward and reverse function.

In an embodiment, the control unit 16 pre-defines a trigger signal S4. When the touch control signal S1 received by the control unit 16 through the touch control area B1 matches the trigger signal S4, the control unit 16 immediately instructs the processing unit 14 to execute the function of the application program AP.

In an embodiment, the trigger signal S4 is a gesture signal, and a trigger travel of the gesture signal is greater than a preset distance, to prevent the control unit 16 from making a misjudgment.

In this embodiment, the control unit 16 sets a single trigger signal S4. In other words, the control unit 16 responds to only one type of touch control signals S1, and instructs the processing unit 14 to execute the function of the application program AP.

In another embodiment, the control unit 16 sets many different types of trigger signals S4, such as a horizontal slide gesture and a vertical slide gesture, and sets different functions for the different trigger signals S4. In this way, the user controls the processing unit 14 to execute the different functions of the application program AP based on different touch control signals S1.

In an embodiment, when the display area 12a of the electronic device 10 further has a touch control input function, the user adjusts a size, a shape, and a position of the touch control area B1 in the sensing area A1 by means of touch control through the display area 12a based on a personal usage habit, and selects an enabling function corresponding to the touch control area B1.

In the foregoing embodiments, the control unit 16 enables only a single touch control area B1 in the sensing area A1, to receive the touch control signal S1. Based on actual requirements, the control unit 16 alternatively enables a plurality of touch control areas B1 in the sensing area A1, to provide more diversified operation modes.

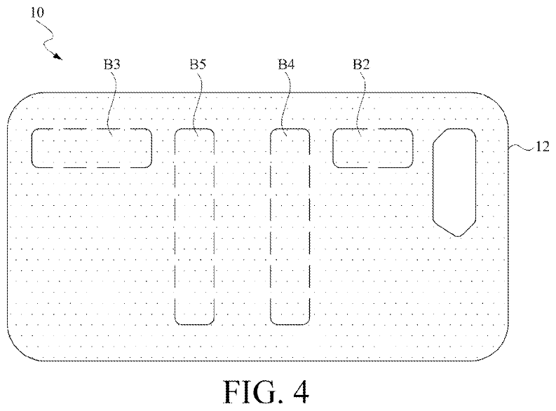

In an embodiment, referring to FIG. 4, FIG. 4 is a schematic diagram of another embodiment of an electronic device according to the disclosure. The control unit 16 detects whether the processing unit 14 executes the application program AP or not, and when the processing unit 14 executes the application program AP, enables a plurality of independent touch control areas (four touch control areas B2, B3, B4, and B5 are shown in the figure) in the sensing area A1.

In an embodiment, the control unit 16 detects types of application programs AP that the processing unit 14 executes, and enables touch control areas with different shapes, sizes, or numbers in the sensing area A1 according to different application programs AP.

The touch control areas B2, B3, B4, and B5 respectively correspond to different functions of the application program AP. In an embodiment, the touch control areas B2, B3, B4, and B5 are approximately bilaterally symmetrically distributed on the back of the housing 12, to correspond to operations of fingers except the thumbs of the left and right hands of the user.

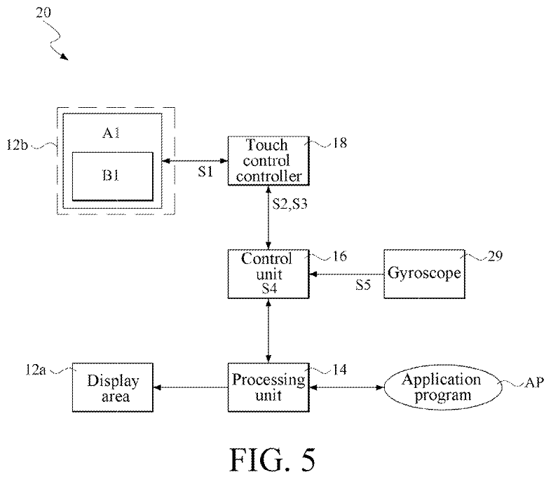

FIG. 5 is a schematic block diagram of still another embodiment of an electronic device according to the disclosure. Compared with the embodiment in FIG. 3, the electronic device 20 in this embodiment further includes a gyroscope 29, configured to detect an orientation of the electronic device 20, to generate an orientation signal S5.

When a processing unit 14 executes an application program AP, in addition to enabling a touch control controller 18, a control unit 16 enables a touch control area B1 in a sensing area based on the orientation signal S5 from the gyroscope 29. After enabling the touch control area B1, the control unit 16 instructs a processing unit 14 to execute a function of the application program AP in response to a touch control signal S1 received in the touch control area B1.

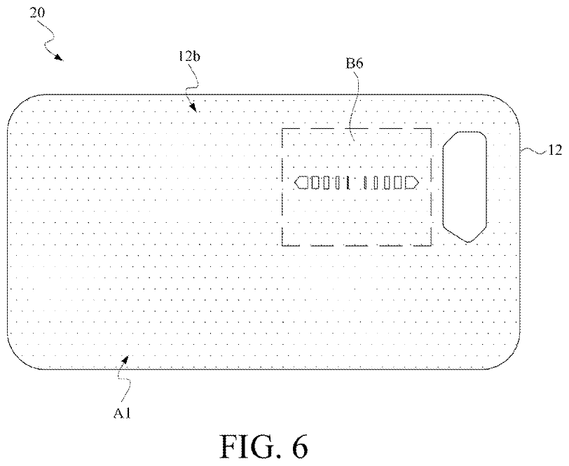

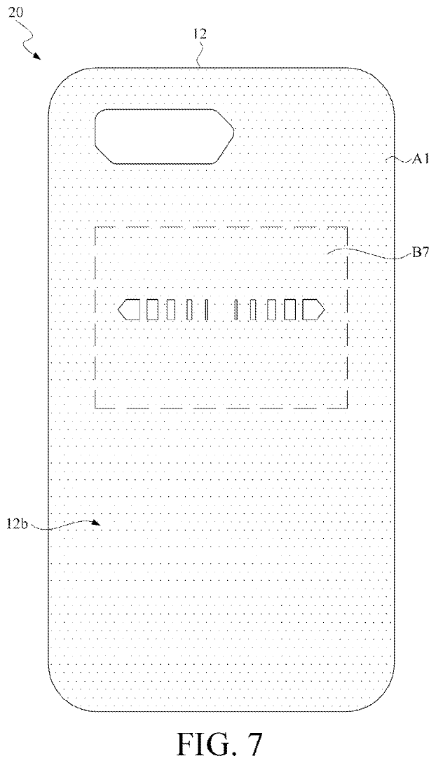

Referring to FIG. 6 and FIG. 7 together, FIG. 6 is a schematic diagram of an embodiment of an electronic device 20 in FIG. 5 in a horizontal state according to the disclosure. FIG. 7 is a schematic diagram of an embodiment of an electronic device 20 in FIG. 5 in a vertical state according to the disclosure.

The orientation signal S5 generated by the gyroscope 29 reflects the electronic device 20 in a horizontal state or in a vertical state. When the processing unit 14 executes the application program AP, the control unit 16 selectively changes a size, a shape, or a position of the touch control area in the sensing area Al based on the orientation signal S5, to match a usage mode of horizontal holding or vertical holding of the user.

As shown in FIG. 6, when the electronic device 20 is in the horizontal state, the control unit 16 generates a touch control area B6 in the sensing area A1. As shown in FIG. 7, when the electronic device 20 is in the vertical state, the control unit generates a touch control area B7 in the sensing area A1. The positions and the sizes of the touch control area B6 and the touch control area B7 are both different.

For generation manners of the touch control areas B6 and B7, in an embodiment, the control unit 16 presets different touch control areas B6 and B7, to correspond to different orientation signals S5. The touch control areas B6 and B7 are both located in the sensing area A1. When the processing unit 14 executes the application program AP, the control unit 16 selects one of the touch control areas (such as the touch control area B7) according to the received orientation signals S5, and is set to preform subsequent processing on only a digital signal S2 whose touch control position is located within the selected touch control area B7.

In an embodiment, the control unit 16 calculates an adjusted touch control area B7 from the original touch control area B6 based on the received orientation signals S5. When the processing unit 14 executes the application program AP, the control unit 16 calculates an adjusted touch control area (such as the touch control area B7) according to the received orientation signals S5, and preforms subsequent processing on only the digital signal S2 whose touch control position is located within the adjusted touch control area B7.

After enabling the touch control areas B6 and B7, the control unit 16 further determines a touch control signal S1 inputted by the user based on an orientation indicated by the orientation signal S5. As shown by directions of arrows in FIG. 6 and FIG. 7, regardless of being in the horizontal state or in the vertical state, the control unit 16 responds to horizontal slide gestures in the touch control areas B6 and B7. In this way, regardless of whether the electronic device 20 is in the horizontal state or in the vertical state, the control unit 16 confirms the touch control signal S1 inputted by the user, and then determines whether the touch control signal S1 inputted by the user matches the trigger signal S4.

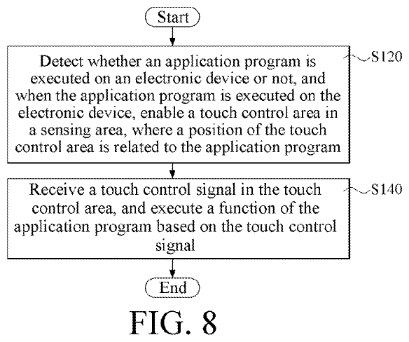

FIG. 8 is a flowchart of an embodiment of an operation method for an electronic device according to the disclosure. The operation method is applicable to the electronic device 10 shown in FIG. 1 to FIG. 3.

First, as described in step S120, whether an application program AP is executed on the electronic device 10 or not is detected, and when the application program AP is executed on the electronic device 10, a touch control area B1 is enabled in the sensing area A1. A position of the touch control area B1 is related to the application program AP.

Then, as described in step S140, a touch control signal S1 is received in the touch control area B1, and a function of the application program AP is executed in response to the touch control signal S1. The function is a function that is easily operated by a gesture among functions of the application program AP.

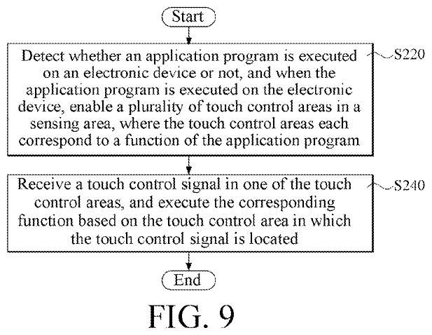

FIG. 9 is a flowchart of another embodiment of an operation method for an electronic device according to the disclosure. The operation method is applicable to the electronic device 10 shown in FIG. 4.

First, as described in step S220, whether an application program AP is executed on the electronic device 10 or not is detected, and when the application program AP is executed on the electronic device 10, touch control areas B2, B3, B4, and B5 are enabled in a sensing area A1. The touch control areas B2, B3, B4, and B5 each correspond to a function of the application program AP.

In an embodiment, when the application program AP is a phone calls program, each of the functions corresponding to the touch control areas B2, B3, B4, and B5 is a volume adjustment function. When the application program AP is a camera program, the function corresponding to the touch control area B1 is an image scaling function. When the application program AP is a game program, the function corresponding to the touch control area B1 corresponds to a plurality of different keys in an application program screen displayed in the display area 12a. When the application program AP is a video player program, each of the functions corresponding to the touch control areas B2, B3, B4, and B5 is a volume adjustment function or a fast forward and reverse function.

Then, as described in step S240, a touch control signal S1 is received through one of the touch control areas B2, B3, B4, and B5, and the corresponding function is executed based on the touch control area in which the touch control signal S1 is located.

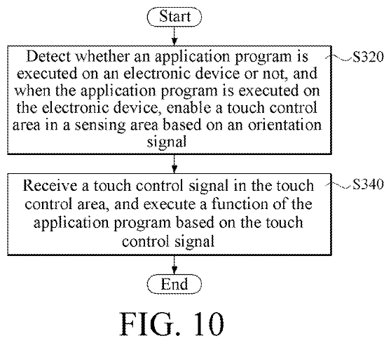

FIG. 10 is a flowchart of still another embodiment of an operation method for an electronic device according to the disclosure. The operation method is applicable to the electronic device 20 shown in FIG. 5 to FIG. 7.

First, as described in step S320, whether an application program AP is executed on the electronic device 20 or not is detected, and when the application program AP is executed on the electronic device 20, a touch control area is enabled in a sensing area A1 based on an orientation signal S5.

The orientation signal S5 indicates that the electronic device 20 is in a vertical state or a horizontal state. In an embodiment, whether the electronic device 20 is in the vertical state or the horizontal state is determined based on the orientation signal, to change a position of the touch control area, such as a touch control area B6 in the horizontal state in FIG. 6, or a touch control area B7 in the vertical state in FIG. 7, to facilitate a holding operation of the user.

Then, as described in step S340, a touch control signal S1 is received in the touch control area, and a function of the application program AP is executed in response to the touch control signal S1. The function is a function that is easily operated by a gesture among functions of the application program AP.

According to the electronic devices 10 and 20, and the operation methods therefor provided in the disclosure, the function of the application program AP is triggered by using a non-display area 12b of the electronic device, to facilitate a real-time operation of the user. In addition, more diversified operation modes are provided through a touch control function of the non-display area 12b, without installing extra extended accessories on the electronic devices 10 and 20.

The above is merely exemplary embodiments of the disclosure, and does not constitute any limitation on the disclosure. Any form of equivalent replacements or modifications to the technical means and technical content disclosed in the disclosure made by a person skilled in the art without departing from the scope of the technical means of the disclosure still fall within the content of the technical means of the disclosure and the protection scope of the disclosure.

1. An operation method for an electronic device, wherein the electronic device comprises a display area and a non-display area, and the non-display area comprises a sensing area, the operation method comprising:
detecting whether an application program is executed on the electronic device or not, and when the application program is executed on the electronic device, enabling a touch control area in the sensing area, wherein a position of the touch control area is adjustable and related to the application program; and
receiving a touch control signal on the touch control area and executing a function of the application program in response to the touch control signal.

2. The operation method for an electronic device according to claim 1, wherein the electronic device is a handheld electronic device.

3. The operation method for an electronic device according to claim 1, wherein the sensing area is located on a back cover of the electronic device.

4. The operation method for an electronic device according to claim 1, wherein the electronic device comprises a gyroscope, the gyroscope being configured to generate an orientation signal.

5. The operation method for an electronic device according to claim 4, wherein the step of enabling the touch control area in the sensing area is enabling the touch control area in the sensing area based on the orientation signal.

6. The operation method for an electronic device according to claim 4, wherein the step of enabling the touch control area in the sensing area comprises selectively changing a size, a shape, or a position of the touch control area in the sensing area based on the orientation signal.

7. The operation method for an electronic device according to claim 1, wherein the application program is a phone calls program, a camera program, a game program, or a player program.

8. The operation method for an electronic device according to claim 1, wherein the electronic device comprises a trigger signal.

9. The operation method for an electronic device according to claim 8, wherein the step of executing the function of the application program is executing the function of the application program when the touch control signal matches the trigger signal.

10. The operation method for an electronic device according to claim 9, wherein the trigger signal is a gesture signal.

11. The operation method for an electronic device according to claim 1, wherein a size, a shape, and a position of the touch control area are adjusted through the display area.

12. An operation method for an electronic device, wherein the electronic device comprises a display area and a non-display area, and the non-display area comprises a sensing area, the operation method comprising:
detecting whether an application program is executed on the electronic device or not, and when the application program is executed on the electronic device, enabling a plurality of touch control areas in the sensing area, wherein each of the touch control areas corresponds to a function of the application program, and a position of each of the touch control areas is adjustable; and
receiving a touch control signal on one of the touch control areas and executing a corresponding function based on the touch control area in which the touch control signal is located.

13. An electronic device, comprising:
a display area and a non-display area, wherein the non-display area comprises a sensing area;
a processing unit, configured to execute an application program; and
a control unit, configured to detect whether the processing unit executes the application program or not, when the processing unit executes the application program, enable a touch control area in the sensing area, wherein a position of the touch control area is adjustable and related to the application program, and instruct the processing unit to execute a function of the application program in response to a touch control signal received in the touch control area.
